(19) United States
(12) Patent Application Publication
(10) Pub. No.: US 2025/0121808 A1
(43) Pub. Date: Apr. 17, 2025

(54) ELECTROHYDRAULIC ACTUATOR DEVICE FOR A MOTOR VEHICLE BRAKE SYSTEM, AND BRAKE SYSTEM HAVING SUCH AN ACTUATOR DEVICE

(71) Applicant: Continental Automotive Technologies GmbH, Hannover (DE)

(72) Inventors: Holger Schmidt, Wettenberg (DE); Robert Grimm, Hofheim (DE); Johannes Görlach, Langgöns (DE); Christian Bitsch, Heppenheim (DE)

(73) Assignee: Continental Automotive Technologies GmbH, Hannover (DE)

(21) Appl. No.: 18/917,510

(22) Filed: Oct. 16, 2024

(30) Foreign Application Priority Data
Oct. 16, 2023 (DE) 10 2023 210 121.
Jan. 18, 2024 (DE) 10 2024 200 450.

(51) Int. Cl. B60T 13/14; B60T 7/04; B60T 13/20; B60T 13/68; B60T 13/74; F15B 15/18

(52) U.S. Cl. CPC B60T 13/148; B60T 7/042; B60T 13/20; B60T 13/686; B60T 13/745; F15B 15/18; B60T 2270/82

(57) ABSTRACT

Electrohydraulic actuator device for a motor vehicle brake system, comprising a cylinder housing, within which a pressure piston is displaced in a translational manner by a rotating threaded spindle, wherein the threaded spindle is driven via a transmission device by a rotor shaft of an electric motor, wherein the actuator device comprises an electronic unit, and a brake system for a motor vehicle having such an electrohydraulic actuator device and a pressure generator, a pressure modulation valve device for the wheel-individual generation of brake pressure at wheel brakes of the brake system, an electronic control device, which is designed for controlling the pressure generator and the pressure modulation valve device, and having a driver's brake actuation device.

### TECHNICAL FIELD

The embodiments to an electrohydraulic actuator device for a motor vehicle brake system and to a brake system having such an actuator device.

### BACKGROUND

DE 42 29 041 A1 discloses a brake actuation apparatus for generating a brake pressure, wherein the brake actuation apparatus has a motor which uses a pinion to drive a gearwheel, to which a screw serving as a screw drive member is fastened. A piston is connected to the screw via a screw connection and is guided in a housing chamber to generate hydraulic pressure. The motor and its drive shaft are positioned parallel to the screw. Above the housing chamber, the housing of the brake actuation device forms a reservoir within which the hydraulic fluid is stored. The reservoir is connected to a cylinder portion of the housing chamber via a breather hole, allowing the hydraulic fluid to flow into the cylinder portion and be delivered under pressure out of an outlet opening by the piston. To do this, the screw engages in a nut that is connected to the piston. When the motor is actuated, its drive shaft moves the screw in a rotational motion via the pinion and the gearwheel, causing the nut with the piston to be moved in a translational manner within the housing chamber.

### SUMMARY

It is the object of the embodiments to provide an electrohydraulic actuator device for a motor vehicle brake system, which, as an integrated functional unit, structurally combines all of the components necessary for generating brake pressure and at the same time can be handled individually, as well as saving on space and weight. In addition, the intention is to provide a brake system which comprises an individually handleable, space-saving and weight-saving electrohydraulic actuator device.

### BRIEF DESCRIPTION OF THE DRAWINGS

In the figures:

FIG. 1 shows a first exemplary electrohydraulic actuator device in perspective view,

FIG. 2 shows the first exemplary actuator device in a first sectional view,

FIG. 3 shows the first exemplary actuator device in a second sectional view,

FIG. 4 shows the circuit diagram of an exemplary brake system with the exemplary electrohydraulic actuator device,

FIG. 5 shows a second exemplary electrohydraulic actuator device in a sectional view, and

FIG. 6 shows the second exemplary electrohydraulic actuator device in an exploded illustration.

### DETAILED DESCRIPTION

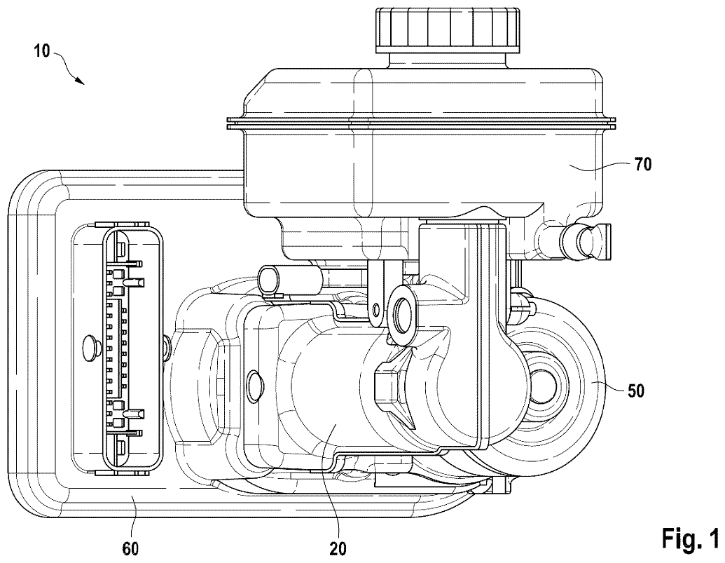

FIG. 1 shows a first exemplary electrohydraulic actuator device 10 for a motor vehicle brake system in a perspective view. As a structurally combined and functional unit, the actuator device 10 comprises all of the necessary components to serve as an independently handleable source for generating a hydraulic pressure. For this purpose, the actuator device 10 comprises a cylinder housing 20 with a piston device located therein, a transmission device, an electric motor 50, an electronic unit 60, and a pressure medium tank 70.

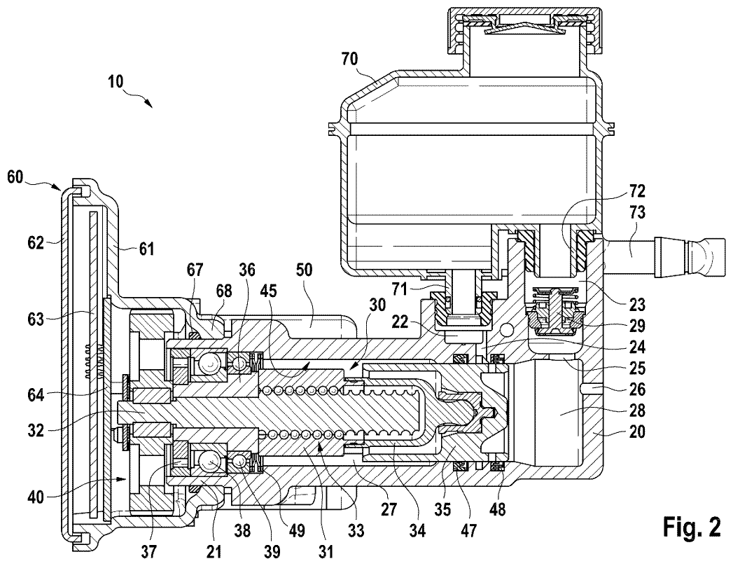

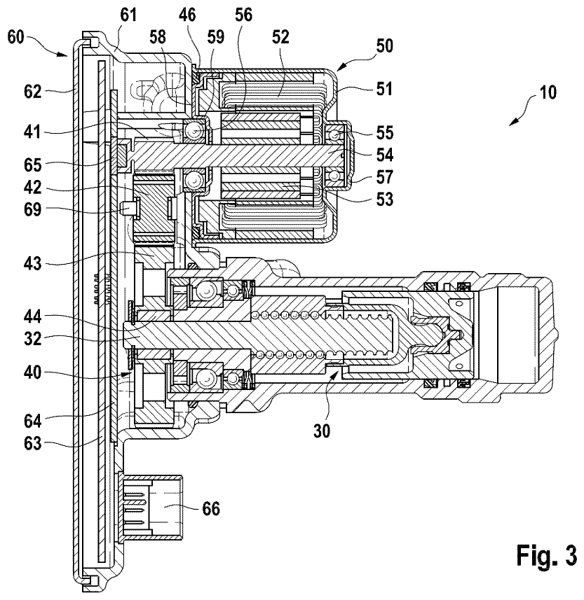

The cylinder housing 20 and electric motor 50 are aligned axially parallel to each other and, for example, are attached jointly and next to each other to the electronic unit 60. The electronic unit 60 thus acts as a central receiving device for fastening the cylinder housing 20 and the electric motor 50. In addition, the housing of the electronic unit 60 is designed in such a way that the transmission device has room within it. Further details of the actuator device 10 will be discussed by the description below of FIGS. 2 and 3.

FIG. 2 shows the first exemplary electrohydraulic actuator device 10 in a first sectional view. The cylinder housing 20, made of aluminum, has an elongate and almost cylindrical shape. A bore 45, which partially comprises different diameters, tapered portions, grooves and annular stops, is introduced into the cylinder housing 20 in the longitudinal direction.

At the open end of the cylinder housing 20, a receiving flange 21 is formed, by means of which the cylinder housing 20 is connected to the electronic unit 60. The receiving flange 21 is rectangular or round. On the side of the cylinder housing 20 opposite the receiving flange 21, a pressure medium tank 70 is arranged on the upper side of said cylinder housing. The upper side of the cylinder housing 20 is determined by the installation position of the actuator device 10 in the motor vehicle.

The pressure medium tank 70 houses a hydraulic fluid under atmospheric pressure. The pressure medium tank 70 comprises a breather hole nozzle 71 and a suction nozzle 72, by means of which said pressure medium tank is plugged onto the cylinder housing 20. For this purpose, the cylinder housing 20 comprises, at the connection point, a first receiving bore 22 for the breather hole nozzle 71 and a second receiving bore 23 for the suction nozzle 72. The first receiving bore 22 and the second receiving bore 23 open in a pressure chamber 28 of the cylinder housing 20, which is bounded by a pressure piston 35 of the piston device 30. In addition, the cylinder housing 20 comprises a pressure outlet opening 26, which also leads into the pressure chamber 28 and from which the hydraulic fluid is delivered under pressure to a pressure medium consumer. In the position shown, the pressure piston 35 is in a position traversing the breather hole opening 24. Furthermore, a nonreturn valve 29 is located in the suction opening 25, said nonreturn valve opening in the direction of the pressure chamber 28 and remaining in the closed position in the opposite direction, as a result of which the pressurized hydraulic fluid cannot flow via the suction opening 25 into the pressure medium tank 70. In addition, the pressure medium tank 70 also comprises a return connection 73, which is designed for the connection of a return line of the brake system, such that the hydraulic fluid from the wheel brakes can flow or be dissipated back into the pressure medium tank 70. If the pressure piston 35 is in a position opening up the breather hole opening 24, also in this position pressure from the wheel brakes can be dissipated via the pressure outlet opening 26 and breather hole opening 24 into the pressure medium tank 70, which is under atmospheric pressure.

The piston device 30 is arranged within the bore 45 of the cylinder housing 20. The piston device 30 comprises a rotatably mounted threaded spindle 32. For this purpose, a bearing package is provided, which is located within the bore 45 and in the region of the receiving flange 21. A first outermost bearing 37 is press-fitted in a force-fitting manner via an external toothing with the bore 45 of the cylinder housing 20. It ensures that the other bearings, but also the piston device 30, are kept in the axial position and do not fall out of the cylinder housing 20. This is followed by a second bearing 38, which receives axial and radial force components of the threaded spindle 32. This is followed by a third bearing 39, which only receives radial force components of the threaded spindle 32. The bearing package is completed by a spring element 49, which is supported on an annular stop within the bore 45 and acts upon the bearing package in a resilient manner in the axial direction.

A bearing bushing 36 is pushed in a force-fitting manner onto the threaded spindle 38 in a central cylindrical portion and is used to mount the threaded spindle 38 in the bearing package. The bearing bushing 36 is formed on the outer side with different outer diameters, which are matched to the diameters of the individual bearings 37, 38 and 39 and are press-fitted therewith. With the outermost and smallest outer diameter, the bearing bushing 36 is received in the first bearing 37. In a central region with a medium outer diameter, the bearing bushing 36 is received in the second bearing 38. With the largest and inner outer diameter, the bushing is received in the third bearing 39.

An end portion or end shaft of the threaded spindle 32 protrudes out of the cylinder housing 20. A gearwheel of the transmission device 40 is plugged onto said end shaft. The drive of the threaded spindle 32 by means of the transmission device 40 is also discussed in the description below of FIG. 3.

The threaded spindle 32 also comprises a threaded portion which is located in a spindle chamber 27 of the cylinder housing 20. A threaded nut 31 which is driven via a ball bearing 33 is displaceable in a translational manner along this portion of the threaded spindle 32. Located in the thread turns of the threaded spindle 32 with the threaded nut 31 are a multiplicity of balls, by means of which the rotational movement of the threaded spindle 32 is converted into a translational movement of the threaded nut 31. The threaded nut 31 together with the bearing bushing 36 is subjected to an axial end stop.

A cylindrical power transmission member 34, onto the dome-shaped head of which the cylindrical pressure piston 35 is plugged, is coupled to the threaded nut 31. By means of the power transmission member 34, the translational movement of the threaded nut 31 is used for the forward and backward movement of the pressure piston 35 within the bore 45 of the cylinder housing 20.

The pressure piston 35 delimits the spindle chamber 27 from the pressure chamber 28. The pressure piston 35 moves along a cylindrical region of the bore 45, which region is matched to the outer diameter of the pressure piston 35. Within said cylindrical region of the bore 45, a first sealing ring 47 is arranged in a first groove, said sealing ring lying in front of the breather hole opening 24 and serving for sealing in relation to the spindle chamber 27. A second sealing ring 48 is arranged in a second groove of the cylindrical region of the bore 45, said sealing ring lying between the breather hole opening 24 and the suction opening 25. With the second sealing ring 48, the pressure chamber 28 is sealed in relation to the breather hole opening 24.

An electronic unit 60 is provided for driving the piston device 30. Said electronic unit controls the electric motor 50, which drives the threaded spindle 32 via the transmission device 40. The electric motor 50 will also be discussed in more detail by the description below regarding FIG. 3. The electronic unit 60 comprises, for example, a two-part housing. The latter may be made of plastic or die-cast aluminum. A printed circuit board 63 is accommodated in a first housing part 61. The printed circuit board 63 is arranged in an extended region of the first housing part 61 and is also shielded from the transmission device 40 by a cooling plate 64. This is because the transmission device 40 is accommodated in a smaller region of the first housing part 61 The extended region of the first housing part 61, within which the printed circuit board 63 is arranged, is made of a plastics material, and the smaller region of the first housing part 61, within which transmission device 40 is accommodated, is made of die-cast aluminum. Furthermore, the first housing part 61 comprises a housing connecting portion 68, into which the receiving flange 21 of the cylinder housing 20 is inserted. In this way, the cylinder housing 20 is connected to the electronic unit 60. This connection is also sealed by a housing sealing ring 67, which is pulled onto the receiving flange 21 and lies against the housing connecting portion 68. The housing of the electronic unit 60 is completed by a second housing part 62, which is substantially in the shape of a cover. Said second housing part is plugged into the extended region of the first housing part 61.

The electric motor 30 and the transmission device 40 will be discussed in more detail with reference to FIG. 3. FIG. 3 shows the actuator device 10 in a second sectional view. The electric motor 50 is attached via its motor housing to the electronic unit 60. The housing comprises a first thermoformed and pot-shaped electric motor housing part 51 and a second cover-shaped electric motor housing part 58. The first electric motor housing part 51 is, for example, screwed via a flange to the first housing part 61 of the electronic unit 60, with the second electric motor housing part 58 being inserted into the first electric motor housing part 51 and lying against the first housing part 61 of the electronic unit 60. A motor sealing ring 46 is also provided for sealing a circumferential groove of the electric motor housing. Furthermore, the electronic unit 60 comprises an electronic connection 66, via which the electronic unit 60 is connected to a control device of the brake system or to a central control device of the motor vehicle.

The first electric motor housing part 51 comprises, at the bottom region, a central first housing eye 57, within which a first rotor bearing 55 is received. The second electric motor housing part 58 comprises, likewise centrally, a second housing eye 59, within which a second rotor bearing 56 is received. In this case, the second housing eye 59 is formed in the housing interior, and therefore the second rotor bearing 56 is placed on the outside of the electric motor housing. In this case, the second rotor bearing 56 is partially located within an opening of the first housing part 61 of the electronic unit 60. A rotor shaft 54 is inserted into the first and second rotor bearings 55 and 56 and press-fitted therewith, as a result of which the rotor shaft 54 is mounted rotatably. The rotor shaft 54 is inserted with one end in the first rotor bearing 55 and protrudes with another end beyond the second rotor bearing 56 and into the electronic unit 60. A first gearwheel 41 of the transmission device 40 is plugged onto this end of the rotor shaft 54. A position sensor 65 is placed in an electrically contacting manner with the printed circuit board 63 and in the axis of rotor shaft 54 to detect the rotation of the rotor shaft 54. This allows the rotor speed and rotor position to be determined, wherein this information is used to precisely displace the piston device 30. To drive the rotor shaft 54, the latter is connected in a force-fitting manner in a central longitudinal portion to a rotor 53. The rotor 53 is driven by energizing a stator 52, which is arranged around rotor 53 in the electric motor housing. The stator 52 is electrically contacted via the printed circuit board 63.

The transmission device 40 furthermore comprises a second gearwheel 42, which is mounted rotatably on a pin 69. The pin 69 is formed on the first housing part 61 of the electronic unit 60. The second gearwheel 42 is operatively connected to the first gearwheel 41 and to a third gearwheel 43, which is connected in a force-fitting manner to the threaded spindle 32 using a bushing 44. By means of the three gearwheels 41, 42 and 43 of the transmission device 40, the rotational movement of the rotor shaft 54 is converted into a rotational movement of the threaded spindle 32. Alternatively, the transmission device 40 may also be designed without a second gearwheel 42, and therefore the first gearwheel 41 is directly operatively connected to the third gearwheel 43. The rotational movement of the threaded spindle 32 is in turn converted into a translational movement of the piston device 30, by means of which the actuator device 10 pressurizes the hydraulic fluid and delivers same to a pressure medium consumer.

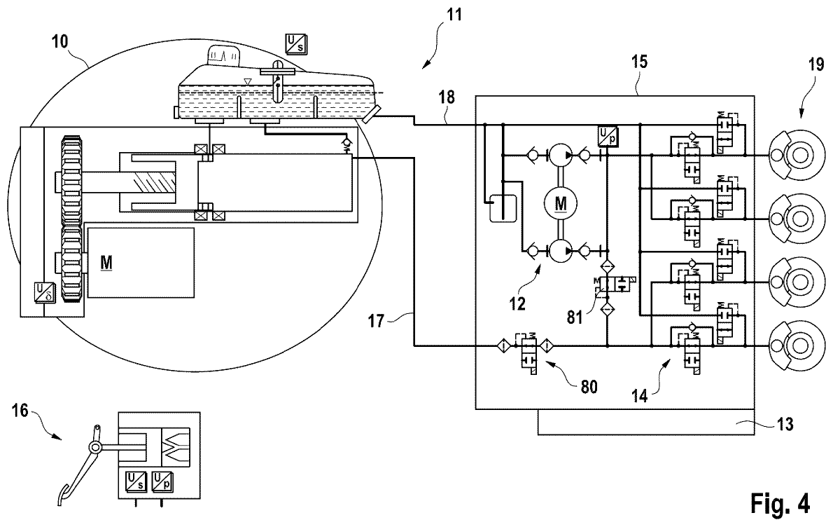

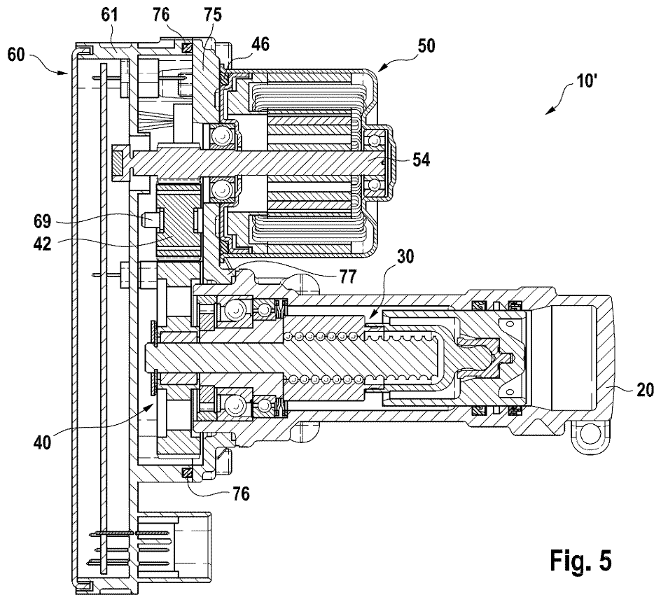

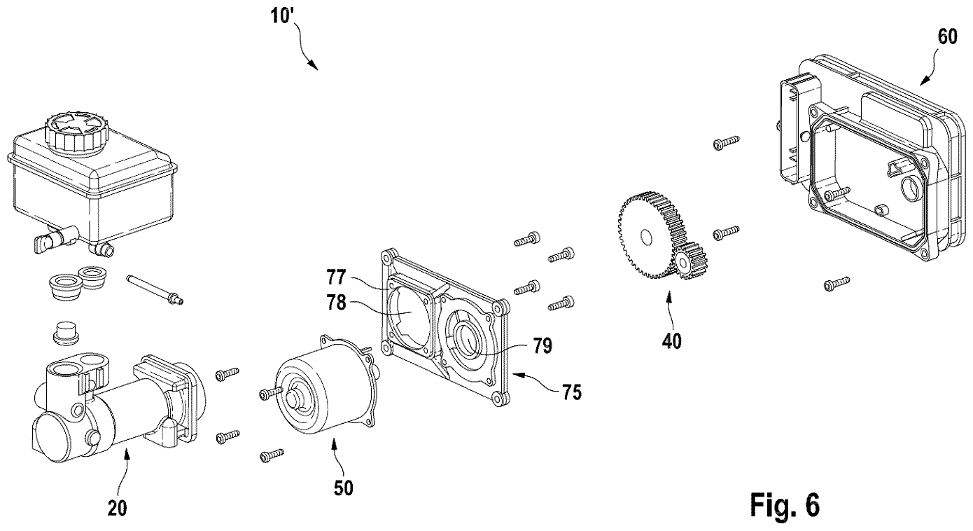

With reference to FIG. 4, an exemplary brake system 11 is shown, which comprises a first exemplary actuator device 10 according to FIGS. 1 to 3 or a second exemplary actuator device 10 according to FIGS. 5 and 6 below. In addition, the brake system 11 comprises an electromotor-operated pressure generator 12, which is designed as a double piston pump, a pressure modulation valve device 14 consisting of a number of inlet and outlet valves, which is designed for the wheel-individual generation of brake pressure at wheel brakes 19, an electronic control device 13, which is designed for controlling the pressure generator 12 and pressure modulation valve device 14, and a driver's brake actuation device 16, which detects the driver's braking request and, when actuated, simulates a brake pressure for the driver.

The pressure generator 12, pressure modulation valve device 14 and electronic control device 13 are structurally and functionally combined to form an electrohydraulic brake control device 15. The latter can be placed in the vehicle separately from the electrohydraulic actuator device 10 and is only connected to the latter via two hydraulic lines. Thus, the pressure outlet of the actuator device 10 is connected to the pressure modulation valve device 14 via a pressure line 17 with the interconnection of a separating valve 80. The pressure generator 12 is fed via a return line 18, which is connected to the pressure medium tank of the actuator device 10, wherein the hydraulic fluid from wheel brakes 19 is dissipated into the pressure medium tank of the actuator device 10 likewise via return line 18.

In addition, the wheel brakes are separated into a first brake circuit I and a second brake circuit II by means of a circuit separation valve 81. Thus, with the actuator device 10 and the circuit separation valve 81 open, the two brake circuits I and II can be supplied with hydraulic pressure, or by closing the circuit separation valve 81, only the second brake circuit II is supplied with hydraulic pressure by the actuator device 10. The same is possible with the pressure generator 12. When the circuit separation valve 81 is closed, this hydraulic fluid is delivered only into the first brake circuit and, when the circuit separation valve 81 is open and the separation valve 80 is closed, it is delivered into both brake circuits I and II. Also a simultaneous operation of the actuator device 10 and pressure generator 12 is possible, and therefore, with the circuit separation valve 81 closed and separation valve 80 open, the actuator device 10 delivers hydraulic fluid into the second brake circuit II and the pressure generator 12 delivers hydraulic fluid into the first brake circuit I. From a structural point of view, the separation valve 80 and circuit separation valve 81 belong to the electrohydraulic brake control device 15 and are controlled by the electronic control device 13 thereof.

By means of the driver brake actuation device 16, the vehicle operator's braking request is detected and transmitted electronically to the actuator device 10 or to the electrohydraulic brake control device 15. These devices are then used to generate a braking pressure electrohydraulically at the wheel brakes 19.

The actuator device 10 is designed to by means of its own electronic device, is independently capable of controlling its electric motor, and of detecting its position in order to provide a hydraulic pressure in a targeted manner. The housing thereof is as small and lightweight as possible. In addition, the actuator device 10 is reduced to the necessary components for pressure generation, which also means that, for example, no electromagnetically switchable valve is arranged on or in the actuator device 10.

FIG. 5 shows, in a sectional view, a second exemplary electrohydraulic actuator device 10′, which comprises a central carrier plate 75, to which the housing 20, electric motor 50 and electronic unit 60 are attached and on which the transmission device 40 is arranged. In this example, the carrier plate 75 serves as a central receptacle for the housing 20, electric motor 50 and electronic unit 60. The carrier plate 75 is, for example, made of die-cast aluminum. The piston device 30, transmission device 40, electric motor 50 and electronic unit 60 do not substantially differ from the first embodiment of the actuator device, and therefore reference is made to the above description.

On a first side of the carrier plate 75, the electric motor 50 is arranged and sealed via the motor sealing ring 46. The rotor shaft 54 protrudes through an opening in the carrier plate 75 in the direction of the electronic unit 60. The housing 20 is furthermore arranged on the first side of the carrier plate 75, specifically via a flange 77 which is formed by the carrier plate 75 and into which the housing 20 is inserted.

The electronic unit 60 is opposite the electric motor 50 with the first housing part 61 and is attached to a second side of the carrier plate 75 using a circumferential sealing ring 76. Furthermore, the transmission device 40 is arranged on the second side of the carrier plate 75, said transmission device being substantially located within the first housing part 61 of the electronic unit 60. In this embodiment, the second gearwheel 42 is received on the carrier plate 75 via a pin 69.

FIG. 6 shows the second exemplary electrohydraulic actuator device 10′ in an exploded illustration. This makes the first receiving opening 78 for the housing 20 and the second receiving opening for the electric motor 50 easier to identify. The housing 20 is designed to be partially plugged onto the flange 77, which is the first receiving opening 78 in the carrier plate 75 and to be fastened on the rear side by means of screw connections. The electric motor 50 is designed to be fastened in the region of the second receiving opening 79 on the front side with the carrier plate 75 likewise by means of screw connections.

The electronic unit 60 is designed to be attached on the rear side to the carrier plate 75, to enclose the transmission device 40 and to be fastened on the front side to the carrier plate 75 by means of screw connections. By using the central carrier plate 75, an easily handleable receiving device for the essential components of the actuator device 10′ is provided, to which said components can be fastened in order to interact with one another. The transmission device 40, which is surrounded by the electronic unit 60 and covered by the carrier plate 75, transmits the motor drive to the piston device for pressure generation and the opposite electronic unit 60 takes over the control of the electric motor 50.

The deliberate omission of solenoid valves in the first and second exemplary actuator device allows the use of a smaller housing for the piston device and thus new design options for the arrangement of the motor and the electronic unit. A compact, lightweight and independent actuator device for generating hydraulic pressure is thus created, either with or without a carrier plate.

1. An electrohydraulic actuator device for a motor vehicle brake system comprising:
a cylinder housing, within which a pressure piston is displaced in a translational manner by
a rotating threaded spindle, wherein the threaded spindle is driven via a transmission device by a rotor shaft of an electric motor, wherein the actuator device comprises an electronic unit.

2. The electrohydraulic actuator device as claimed in claim 1, wherein the cylinder housing and the electric motor are arranged on the electronic unit.

3. The electrohydraulic actuator device as claimed in claim 1, wherein the cylinder housing and the electric motor are arranged on a carrier plate, and the electronic unit is arranged opposite them on the carrier plate.

4. The electrohydraulic actuator device as claimed in claim 3, wherein the carrier plate comprises a first receiving opening, at which the cylinder housing is attached, and wherein the carrier plate comprises a second receiving opening, at which the electric motor is attached.

5. The electrohydraulic actuator device as claimed claim 1, wherein the electronic unit is aligned orthogonally to the cylinder housing and the electric motor.

6. The electrohydraulic actuator device as claimed in claim 1, wherein the transmission device is arranged between the cylinder housing and the electric motor and the electronic unit.

7. The actuator device as claimed in claim 1, wherein the electronic unit comprises a first housing part, within which the transmission device is received.

8. The actuator device as claimed in claim 1, wherein the transmission device comprises a first gearwheel, which is attached to the rotor shaft, and a further gearwheel, which is attached to the threaded spindle, the first and the further gearwheels being operatively connected.

9. The actuator device as claimed in claim 1, wherein the transmission device comprises a first gearwheel, which is attached to the rotor shaft, a second gearwheel, which is mounted on a pin within the electronic unit, and a third gearwheel, which is attached to the threaded spindle, the second gearwheel being operatively connected to the first and the third gearwheels.

10. The actuator device as claimed in claim 1, wherein the threaded spindle is aligned axially parallel to the rotor shaft.

11. The actuator device as claimed in claim 1, wherein the electronic unit is designed for controlling the electric motor and sensing its rotational position.

12. A brake system for a motor vehicle, comprising:
an electrohydraulic actuator device having a cylinder housing, within which a pressure piston is displaced in a translational manner by a rotating threaded spindle, wherein the threaded spindle is driven via a transmission device by a rotor shaft of an electric motor, wherein the actuator device comprises an electronic unit;
a pressure generator;
a pressure modulation valve device for the wheel-individual generation of brake pressure at wheel brakes of the brake system; and
an electronic control device, for controlling the pressure generator and the pressure modulation valve device, and a driver's brake actuation device.

13. The brake system as claimed in claim 12, wherein the actuator device is connected hydraulically on the pressure side via a pressure line to the pressure modulation valve device.

14. The brake system as claimed in claim 13, wherein the interconnection of a separation valve, and wherein the pressure generator and the pressure modulation valve device are hydraulically connected via a return line to a pressure medium tank of the actuator device.

15. The brake system as claimed in claim 13, wherein the actuator device is hydraulically connected via a breather hole opening to the pressure medium tank such that a pressure from the wheel brakes is dissipated via the actuator device into the pressure medium tank.

16. The brake system as claimed in claim 12, wherein the pressure generator, the pressure modulation valve device, and the electronic control device are structurally combined to form an electrohydraulic brake control device, which is structurally separated from the actuator device.

17. The brake system as claimed in claim 12, wherein the actuator device does not comprise an electromagnetically actuable switching valve.

18. The brake system as claimed in claim 12, wherein the driver's brake actuation device has no mechanical and/or hydraulic operative connection to the pressure modulation valve device.
